(19) United States
(12) Patent Application Publication
(10) Pub. No.: US 2015/0334759 A1
(43) Pub. Date: Nov. 19, 2015

(54) COMMUNICATION APPARATUS, CONTROL METHOD, AND STORAGE MEDIUM

(71) Applicant: CANON KABUSHIKI KAISHA, Tokyo (JP)

(72) Inventor: Fukiko Hiramatsu, Fuchu-shi (JP)

(21) Appl. No.: 14/711,004

(22) Filed: May 13, 2015

(30) Foreign Application Priority Data
May 16, 2014 (JP) 2014-102170

(51) Int. Cl. H04W 76/02; H04W 48/02; H04W 48/16

(52) U.S. Cl. CPC H04W 76/023; H04W 48/16; H04W 48/02; H04W 76/027; H04W 84/20

(57) ABSTRACT

A communication apparatus includes a storage unit that stores first information corresponding to an apparatus that establishes a predetermined wireless network, a reception unit that receives an invitation request signal indicating an invitation to a wireless network, and a confirmation unit that, in a case where a wireless network associated with the invitation request signal is not the predetermined wireless network, confirm whether to connect to the wireless network, and in a case where a wireless network associated with the invitation request signal is the predetermined wireless network, omit the confirmation.

### BACKGROUND

1. Field

Aspects of the present invention generally relate to a communication apparatus connected to a wireless network.

2. Description of the Related Art

The Wi-Fi Alliance® has established the Wi-Fi Peer-to-Peer (hereinbelow, P2P) standard (Japanese Patent Application Laid-Open No. 2011-244151). In the P2P standard, an invitation request signal is defined that is a signal for inviting other communication apparatuses to connect a predetermined wireless network.

There is a technique for asking a user whether to accept connection of a communication apparatus to a predetermined wireless network when an invitation request signal is received and connecting to the predetermined wireless network if the user accepts connection.

According to this technique, when the communication apparatus receives an invitation request and connects to the wireless network, a user performs an operation to accept or refuse connection, which is cumbersome for the user.

### SUMMARY

Aspects of the present invention are generally directed to a communication apparatus that can simplify a user operation to connect to a wireless network.

According to an aspect of the present invention, a communication apparatus includes a storage unit configured to store first information corresponding to an apparatus that establishes a predetermined wireless network, a reception unit configured to receive an invitation request signal indicating an invitation to a wireless network, and a confirmation unit configured to, in a case where a wireless network associated with the invitation request signal is not the predetermined wireless network, confirm whether to connect to the wireless network, wherein in a case where a wireless network associated with the invitation request signal is the predetermined wireless network, confirmation is omitted.

Further features of the present disclosure will become apparent from the following description of exemplary embodiments with reference to the attached drawings.

### BRIEF DESCRIPTION OF THE DRAWINGS

FIG. 1 illustrates a wireless communication system regarding a non-persistent group.

FIG. 2 illustrates a wireless communication system regarding a persistent group.

FIG. 3 illustrates a configuration of an invitation request frame.

FIGS. 4A and 4B are block diagrams illustrating a function configuration of a wireless communication apparatus.

FIG. 5 (including FIGS. 5A and 5B) is a sequence diagram illustrating processing among apparatuses.

FIG. 6 is a flowchart illustrating processing performed by the wireless communication apparatus.

FIG. 7 illustrates a wireless communication system regarding a non-persistent group.

FIG. 8 illustrates a wireless communication system regarding a persistent group.

FIG. 9 (including FIGS. 9A and 9B) is a sequence diagram illustrating processing among apparatuses.

FIG. 10 (including FIGS. 10A and 10B) is a flowchart illustrating processing performed by the wireless communication apparatus.

### DESCRIPTION OF THE EMBODIMENTS

A communication apparatus according to exemplary embodiments will be described in detail below with reference to the drawings. The communication apparatus is described below as an example that uses a wireless local area network (LAN) system conforming to Institute of Electrical and Electronics Engineers (IEEE) 802.11 series.

The wireless LAN conforming to the IEEE 802.11 series standards includes two modes, that is an infrastructure mode and an ad-hoc mode. The infrastructure mode includes an access point (hereinbelow, AP, i.e., a base station) that manages the wireless network and a station (hereinbelow, STA, i.e., a slave station) that performs communication by connecting to the wireless network.

The Wi-Fi P2P standard has been established by the Wi-Fi Alliance®. In the P2P standard, a P2P group is defined as a wireless communication network including a P2P group owner (hereinbelow, P2P-GO) and a P2P client (hereinbelow, P2P-CL). In the P2P group, the P2P-CL serving as the slave station connects to the P2P-GO serving as the base station, and thus communication is established.

A media access control (MAC) layer of the wireless LAN has adopted Carrier Sense Multiple Access/Collision Avoidance (CSMA/CS). Thus, a plurality of communication apparatuses can use the same radio frequency channel (hereinbelow, channel) in communication. In the wireless communication in the wireless LAN or the like, communication apparatuses cannot communicate with each other if they use different channels, so that the communication apparatuses to communicate with each other need to set to the same channel.

Thus, a timing when an AP changes the channel is generally when a user issues an instruction or when the AP autonomously detects deterioration of a radio wave environment, and the AP does not frequently change the channel. On the other hand, when an STA searches for a desired AP, the STA searches for a network (performs scanning) while changing channels. Thus, the STA frequently changes the channel in some cases.

An AP function operating as an AP or an STA function operating as an STA can be operated concurrently with a P2P-GO function operating as a P2P-GO or a P2P-CL function operating as a P2P-CL. A wireless communication apparatus that performs such a concurrent operation is referred to as a dual apparatus.

The dual apparatus that concurrently operates the STA function with the P2P-GO function or the P2P-CL function is described below.

When the STA function and the P2P-GO function or the P2P-CL function are operated at different channels, the dual apparatus needs to include two pieces of radio hardware for setting the channels. Providing two pieces of the radio hardware increases a cost of the communication apparatus.

Thus, according to the present exemplary embodiment, the dual apparatus shares single radio hardware between the AP function or the STA function and the P2P-GO function or the P2P-CL function and uses the same channel in the both functions.

Therefore, in a case where the dual apparatus changes the AP to which the STA function thereof is connected and a channel used by a newly connected AP is different from that of the AP previously connected, the radio hardware of the dual apparatus needs to adjust the channel to the new one. Accordingly, the channel used by the P2P-GO function or the P2P-CL function in the concurrent operation becomes unavailable, and connection to the P2P group using the original channel cannot be maintained.

In this case, if the P2P-GO function is being operated, the dual apparatus needs to dissolve the P2P group. Further, if the P2P-CL function is being operated, the dual apparatus needs to disconnect from the P2P group to which the dual apparatus belongs before changing the channel.

If the dual apparatus reconnects to the P2P group connected in the past after changing the channel, there is a method for transmitting an invitation request signal to a wireless communication apparatus that is an apparatus participating in the relevant P2P group (hereinbelow, member).

An invitation request signal (hereinbelow, simply referred to as an invitation request) is an invitation signal for inviting another communication apparatus to a predetermined wireless network (the P2P group). An invitation request may be referred to as a P2P invitation request since a signal is defined by the P2P standard.

The invitation request includes an invitation flag, an operating channel, a Basic Service Set Identifier (BSSID, identification information of the wireless network to be a connection destination) of the group, a channel list, a P2P group ID, P2P device information, and the like, which are described below. At least any of the P2P group ID and the P2P device information includes a MAC address of the P2P-GO that established the P2P group to be the connection destination. Thus, when the invitation request is analyzed, the P2P-GO that established the P2P group to be the connection destination can be identified.

An invitation request can be transmitted in a plurality of cases. For example, one case is that a group to which the dual apparatus belongs immediately before then is a persistent group defined by the P2P standard, which is a permanent P2P group. In this case, both of the P2P-GO and the P2P-CL that once disconnected from the P2P group can transmit the invitation request.

In the case of the persistent group, both of the P2P-GO and the P2P-CL remain storing communication parameters used for connection after dissolution of the group. Thus, an invitation request can be transmitted from not only a wireless communication apparatus serving as a P2P-GO but also a wireless communication apparatus serving as a P2P-CL.

The communication parameter includes information pieces, such as a service set identifier (SSID) as identification information of the network, an encryption key, an encryption method, an authentication method, and an authentication key.

When a received invitation request is a request for connection to the persistent group, the dual apparatus performs only an authentication procedure without newly sharing the communication parameter to participate in the group.

On the other hand, there is a case that a group to which the dual apparatus belongs immediately before then is a non-persistent group defined by the P2P standard, which is a temporary P2P group. In the case of the non-persistent group, a former member of the P2P group does not store the communication parameter after dissolution of the group. In the case of the non-persistent group, the P2P-GO and the P2P-CL already belonging to the relevant P2P group can transmit an invitation request.

Whether an invitation request is a request for connection to the non-persistent group or a request for connection to the persistent group can be identified by analyzing an invitation flag of the invitation request.

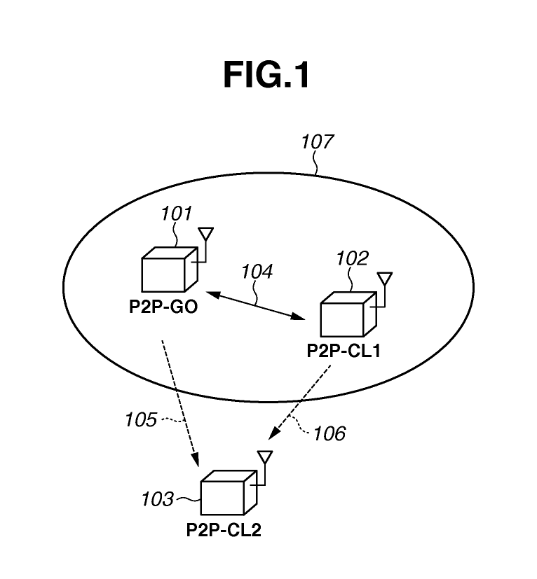

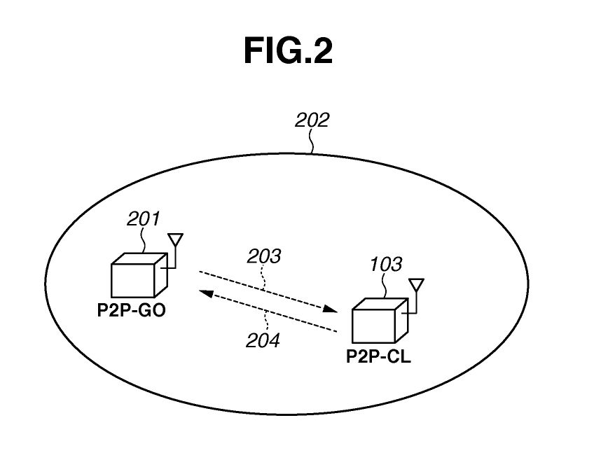

FIGS. 1 and 2 illustrate configurations of a system according to a first exemplary embodiment.

FIG. 1 is a system configuration in a case where a wireless communication apparatus participates in a non-persistent mode P2P group in which a P2P-GO and a P2P-CL perform P2P communication therebetween.

The system includes a wireless communication apparatus 103 according to the present exemplary embodiment. A P2P-GO 101 exists in a non-persistent group 107, and a P2P-CL 102 is a member of the non-persistent group 107. The P2P-GO 101 and the P2P-CL 102 have already performed P2P communication 104 therebetween.

The P2P-GO 101 transmits an invitation request 105 to the wireless communication apparatus 103, and the P2P-CL 102 transmits an invitation request 106 to the wireless communication apparatus 103. The non-persistent group 107 is established by the P2P-GO 101.

In FIG. 1, the wireless communication apparatus 103 can connect to the P2P group by the invitation request in two different methods. A first method is that the wireless communication apparatus 103 directly receives the invitation request 105 from the P2P-GO 101. A second method is that the wireless communication apparatus 103 receives the invitation request 106 from the P2P-CL1 102 that is already the member of the P2P group. In order to be the P2P-CL, the wireless communication apparatus 103 needs to complete sharing processing of the wireless communication parameter by performing provision discovery, Wi-Fi Protected Setup® (WPS), and other processing after receiving the invitation request.

FIG. 2 is a system configuration in a case where a P2P-GO causes a wireless communication apparatus to participate in a persistent mode P2P group.

The system includes the wireless communication apparatus 103 according to the present exemplary embodiment. A P2P-GO 201 exists in a persistent group 202. The persistent group 202 is generated by the P2P-GO 201. The P2P-GO 201 transmits an invitation request 203 to the wireless communication apparatus 103, and the wireless communication apparatus 103 transmits an invitation request 204 to the P2P-GO 201.

In FIG. 2, the wireless communication apparatus 103 is also a P2P-CL in the persistent group 202.

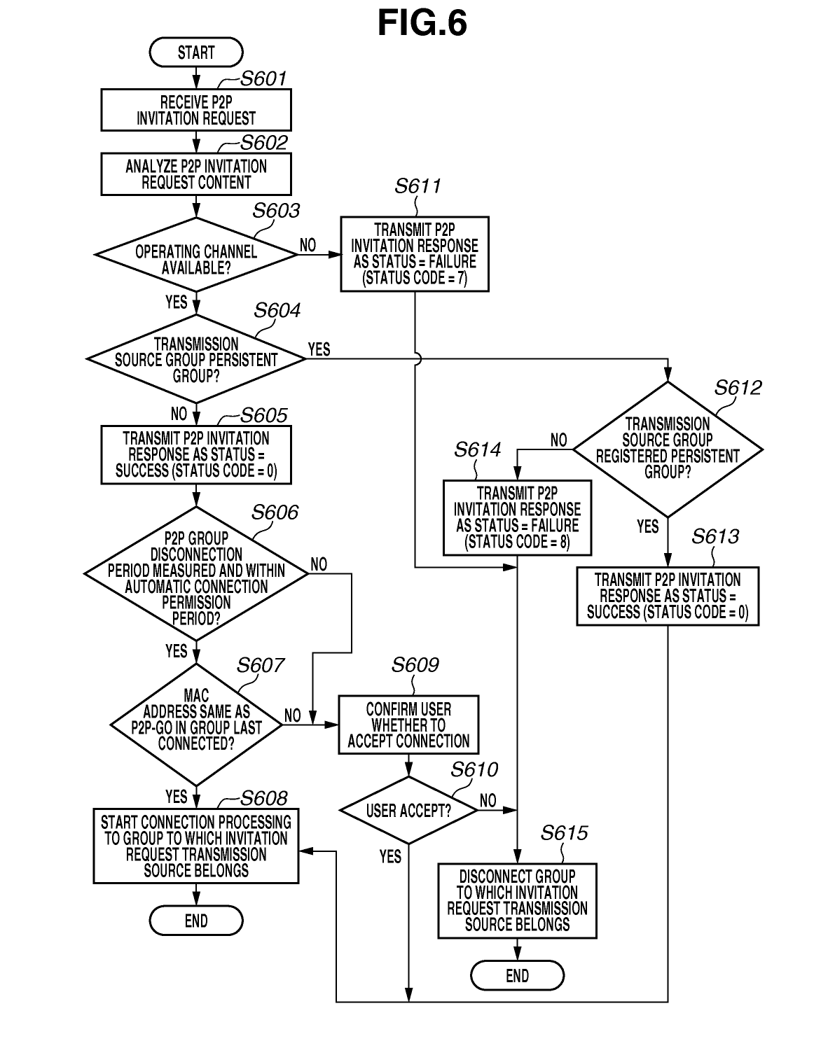

In FIG. 2, the both apparatuses can transmit the invitation request (203 or 204) to add the wireless communication apparatus 103 to a member of the persistent group 202. Regarding the persistent group, the stored authentication information pieces are not changed, and thus the sharing processing of the wireless communication parameter is not necessary to be performed after receiving the invitation request. In FIG. 2, the P2P-CL side is the wireless communication apparatus realizing processing in a flowchart in FIG. 6, which is described below. However, the present exemplary embodiment is not limited to this configuration, the wireless communication apparatus 103 realizing the below described processing in the flowchart in FIG. 6 may be the P2P-GO, and the partner apparatus 201 may be the P2P-CL.

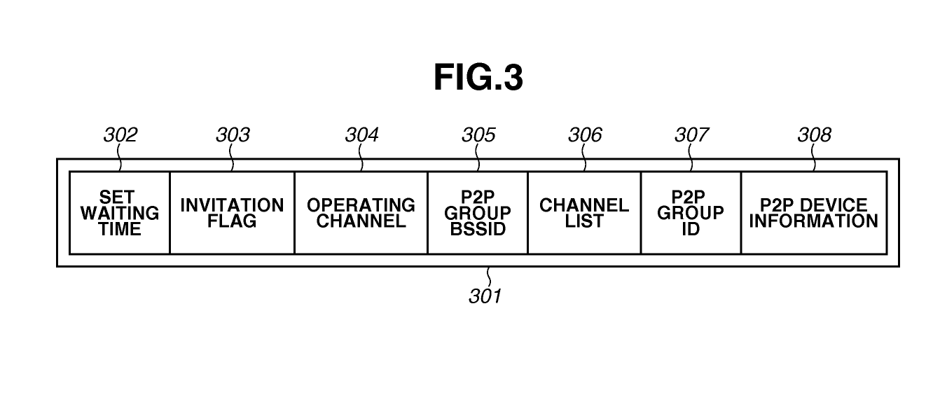

FIG. 3 illustrates a configuration of frames of the invitation requests 105, 106, 203, and 204.

The invitation request has an entire frame 301.

A set waiting time 302 is a time period necessary to shift from a current mode to the P2P-GO or the P2P-CL. An invitation flag 303 indicates whether the invitation request is transmitted from the non-persistent group or from the persistent group. In other words, the invitation flag is information indicating a group type of the wireless network as a destination to which an apparatus received the invitation request intends to connect.

An operating channel 304 is a communication channel in the P2P group. A P2P group BSSID 305 is a BSSID of the P2P-GO. A channel list 306 is a list of channels that the apparatus transmitted the invitation request can use in communication. A P2P group ID 307 includes identification information (ID) of the P2P-GO in the P2P group that forms the P2P group and an SSID of the relevant P2P group. P2P device information 308 includes various information pieces, such as an address and a name of a P2P device, and a method for Wi-Fi Simple Config (WSC).

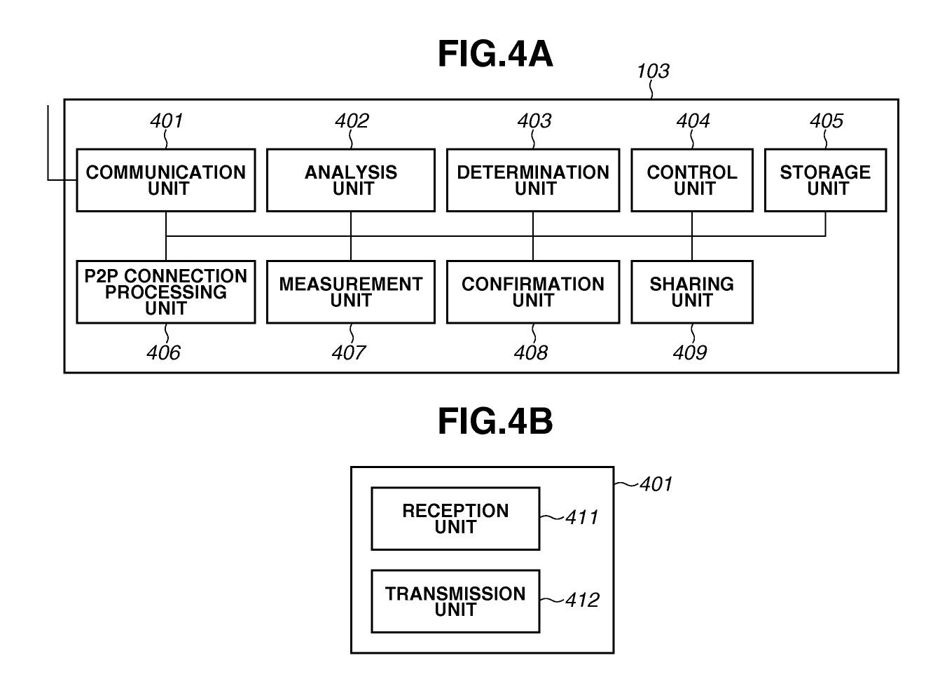

FIG. 4A is a block diagram illustrating an example of a function configuration of the wireless communication apparatus 103. The wireless communication apparatus 103 includes a communication unit 401, an analysis unit 402, a determination unit 403, and a control unit 404. The wireless communication apparatus 103 further includes a storage unit 405, a P2P connection processing unit 406, a measurement unit 407, a confirmation unit 408, and a sharing unit 409.

The communication unit 401 transmits and receives radio data by a wireless LAN system conforming to the IEEE 802.11 series. As illustrated in FIG. 4B, the communication unit 401 further includes a transmission unit 412 and a reception unit 411. The reception unit 411 receives radio data, such as an invitation request. The transmission unit 412 transmits radio data, such as an invitation response that is a response signal to the invitation request.

The control unit 404 includes a central processing unit (CPU) or other components and controls transmission and reception of a message.

When the communication unit 401 receives the P2P invitation request, the analysis unit 402 analyzes the invitation request. After the analysis, the analysis unit 402 immediately generates a frame for responding to the invitation request and transmits the frame to the communication unit 401. Analysis of the invitation request is to break the invitation request frame 301 down into the information pieces 302 to 308 and to analyze the invitation flag, the MAC address of the P2P-GO, the P2P group name, the authentication method, and the like.

The storage unit 405 includes a read-only memory (ROM), a random access memory (RAM), and the like and stores the following information pieces regarding forming the persistent group and a most recent non-persistent group. More specifically, a role (the P2P-GO or the P2P-CL), the MAC address of the P2P-GO, a group name, communication parameter setting information, information about the authentication method, and the like are stored. Further, the storage unit 405 stores an automatic connection permission time period that is a predetermined time period indicating a maximum time period to allow automatic connection without a user operation if an invitation request is transmitted from the P2P group of the same P2P-GO after disconnection from the P2P group.

The measurement unit 407 measures a P2P group disconnection period that is a time period from when the wireless communication apparatus 103 disconnects from the non-persistent group to when connecting to a next P2P group. The P2P group disconnection period is initialized when the wireless communication apparatus 103 connects to the non-persistent group.

The type of the P2P group (the non-persistent group or the persistent group) and the MAC address of the P2P-GO can be obtained by analysis by the analysis unit 402. The P2P group disconnection period is measured by the measurement unit 407. These information pieces, namely the type of the P2P group, the MAC address of the P2P-GO, and the P2P group disconnection period are compared by the determination unit 403 with those stored in the storage unit 405.

The determination unit 403 performs the following determination.

The determination unit 403 determines whether a transmission source of the invitation request matches with the P2P-GO in the persistent group stored in the storage unit 405. The determination is made based on the MAC address. The determination unit 403 further determines whether the P2P group disconnection period is within the automatic connection permission time period. When results are positive in both determinations, the determination unit 403 determines that automatic connection can be performed. When results are other than that, the determination unit 403 determines that the automatic connection cannot be performed.

The determination unit 403 also determines whether the transmission source of the invitation request matches with the P2P-GO in the non-persistent group stored in the storage unit 405. The determination is made based on the MAC address. The determination unit 403 further determines whether the P2P group disconnection period is within the automatic connection permission time period. When results are positive in both determinations, the determination unit 403 determines that automatic connection can be performed. When results are other than that, the determination unit 403 determines that the automatic connection cannot be performed.

When the determination unit 403 determines that the connection can be performed, the P2P connection processing unit 406 performs connection to the P2P group without a user operation. When the determination unit 403 determines that the connection cannot be performed, the P2P connection processing unit 406 waits for a user operation and performs connection to the P2P group that transmitted the invitation request only when the user accepts the connection.

When connection to a predetermined wireless network (P2P group) is requested by an invitation request, the confirmation unit 408 confirms with (asks) a user whether to accept the connection to the predetermined wireless network. The confirmation is performed, for example, by displaying a confirmation message, like “do you accept a connection?” on a display unit together with the SSID of the predetermined wireless network. The confirmation message may be displayed on a display unit of an apparatus different from the wireless communication apparatus 103.

The sharing unit 409 performs processing to share the communication parameter with another communication apparatus (for example, the P2P-GO in the wireless network to be the connection destination) by WPS and the like.

All function blocks are interrelated with each other by software and by hardware. The above-described function block configuration is an example, so that a plurality of function blocks may form a single function block, and any of the function block may be further divided into blocks providing a plurality of functions. When each of the function blocks illustrated in FIG. 4 is configured as hardware, the function blocks include a CPU, various memories (ROM, RAM, HDD, and the like), a wireless communication interface, an operation unit, a display unit, and other units. Further, when each of the function blocks illustrated in FIG. 4 is configured as software, the function blocks are stored in a memory as a program, and the wireless communication apparatus 103 is operated by the CPU executing the program.

In FIG. 1, the P2P-GO 101 is the dual apparatus that concurrently operates the STA function. The P2P-GO 101 forms the non-persistent group that includes the P2P-CL 103. In the following description, the relevant P2P-CL is referred to as the P2P-CL 103.

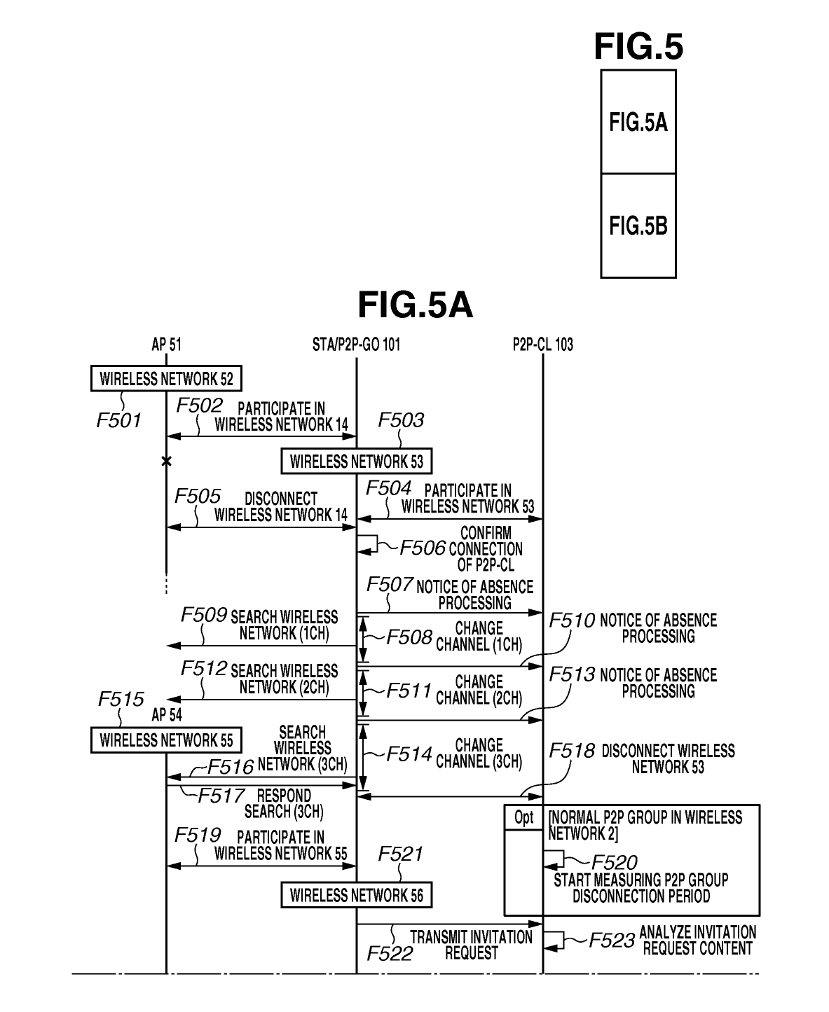

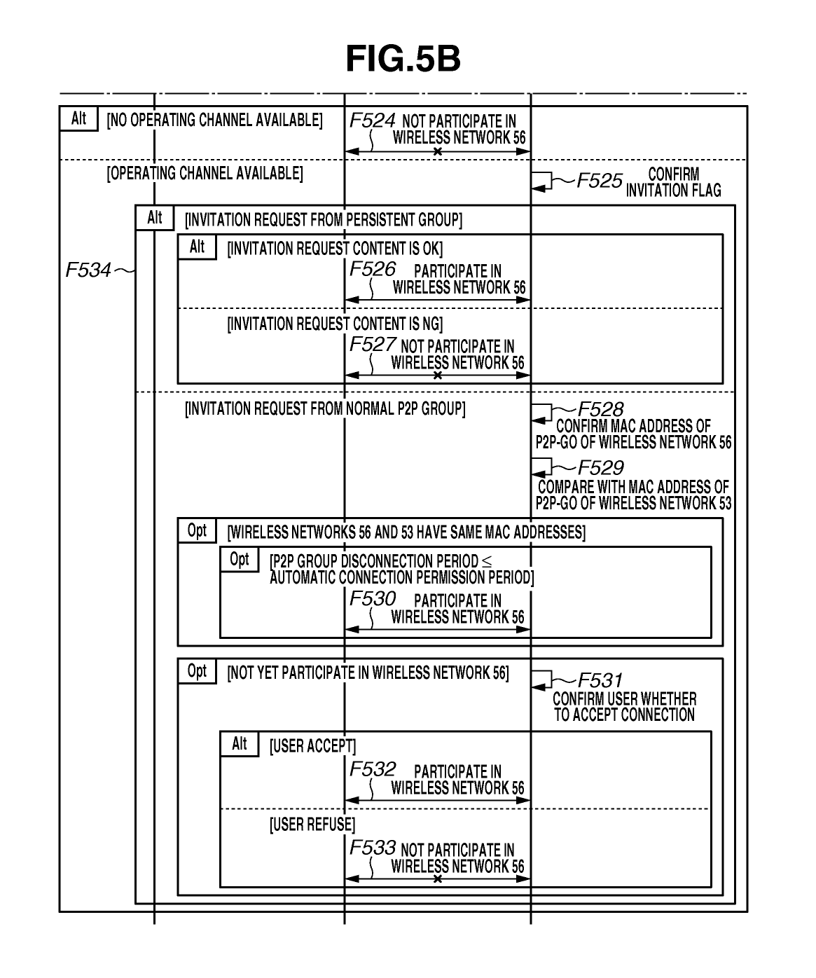

FIG. 5 (including FIGS. 5A and 5B) is a sequence diagram when the dual apparatus 101 that concurrently operates the STA function and the P2P-GO function performs roaming from a wireless network 52 to a wireless network 55.

In step F501, an AP 51 establishes the wireless network 52 in a predetermined channel (here, channel 10). In step F502, the dual apparatus 101 connects to the AP 51 by the STA function. In other words, the dual apparatus 101 participates in the wireless network 52 established by the AP 51. In step F503, the dual apparatus 101 establishes the wireless network 53 by itself by the P2P-GO function. The wireless network 53 is established in a channel (channel 10) same as that of the wireless network to which the STA function of the dual apparatus 101 connects. In step F504, the P2P-CL 103 connects to the dual apparatus 101. In other words, the P2P-CL 103 participates in the wireless network 53 in step F504.

The connection of the P2P-GO function in the dual apparatus 101 and the P2P-CL 103 uses P2P group formation processing and P2P invitation processing defined in the P2P standard. At that time, user operations are performed for determining availability of a connection target device and an authentication method.

If the P2P-CL 103 participates in the wireless network 53, the MAC address information of the dual apparatus 101 is stored in the storage unit 405 in the P2P-CL 103 after the P2P-CL 103 disconnected from the wireless network 53.

Next, in step F505, wireless communication between the dual apparatus 101 and the wireless network 52 is disconnected. A cause of disconnection of the wireless communication is, for example, that the dual apparatus 101 gets out of a range of the wireless communication of the wireless network 52, and that the AP 51 is stopped. In step F506, the dual apparatus 101 confirms whether the P2P-CL exists in the wireless network 53. If the dual apparatus 101 confirms the existence of the P2P-CL 103 in the wireless network 53, in step F507, the dual apparatus 101 notifies the P2P-CL 103 of a schedule when the dual apparatus 101 is to be absent from the wireless network 53. This processing is referred to as notice of absence (NoA) processing below.

Here, a state that the dual apparatus 101 is absent from the wireless network 53 is, for example, that the dual apparatus 101 performs communication in a channel different from the channel (channel 10) that is used in the wireless network 53.

The P2P-CL is thus noticed of the absence by the NoA processing, the P2P-CL can avoid disconnecting from the wireless network 53 if communication with the P2P-GO is not available. Therefore, the present exemplary embodiment can produce an effect that the P2P group can be maintained if the dual apparatus 101 is absent from the wireless network 53.

In step F508, the dual apparatus 101 changes the channel to use to a channel 1 based on the schedule notified in the NoA processing. When the channel change is completed, in step F509, the dual apparatus 101 transmits a wireless network search request signal (hereinbelow, a search request) in the channel 1. The search request is, for example, a probe request signal conforming to the IEEE 802.11 series standards.

In this case, a wireless network having a desired SSID does not exist in the channel 1, so that the dual apparatus 101 does not connect to a new wireless network. When the dual apparatus 101 terminates the change to the channel 1 and returns to the channel 10, in steps F510 to F517, the dual apparatus 101 repeats the search for a wireless network by changing the channel to use as in the case of the search for the wireless network in the channel 1. While the wireless network search is repeated, in step F514, the dual apparatus 101 performs searching in a channel 3, and in step F517, receives a search response signal from the wireless network 55 having the desired SSID established by the AP 54. The search response signal (hereinbelow, a search response) is, for example, a probe response signal conforming to the IEEE 802.11 series standards. Thus, the dual apparatus 101 finds the wireless network 55 established by the AP 54.

When the dual apparatus 101 terminates the change to the channel 3 and returns to the channel 10, in step F518, the dual apparatus 101 terminates the wireless network 53 to disconnect from the P2P-CL 103 before connecting to the wireless network 55 in the channel 3. In step F520, the P2P-CL 103 starts measurement of a time period when the P2P-CL 103 does not connect to the P2P group in response to disconnection from the wireless network 53. In the following description, a time period when the P2P-CL 103 does not connect to the P2P group is referred to as a P2P group disconnection period.

In step F519, the dual apparatus 101 changes the channel to use to the channel 3 and participates in the wireless network 55. Then, in step F521, the dual apparatus 101 establishes a wireless network 56 by the P2P-GO function. The wireless network 56 is established in the channel (channel 3) same as that of the wireless network 55 to which the STA function of the dual apparatus 101 connects. At that time, the SSID and packet encryption and decryption passwords of the wireless network 56 may be different from the SSID and packet encryption and decryption passwords of the wireless network 53.

In step F522, the dual apparatus 101 that completes establishment of the wireless network 56 performs invitation request processing by transmitting a P2P invitation request to the P2P-CL 103. In step F523, the analysis unit 402 receives the invitation request and analyzes contents thereof.

First, the analysis unit 402 confirms whether the operating channel 304 and the channel list 306 indicated in the invitation request include a channel available to the P2P-CL 103. If the channel available to the P2P-CL 103 is not included, in step F524, the transmission unit 412 transmits to the P2P-GO 101 an invitation response signal indicating an error. The invitation response signal (hereinbelow, an invitation response) is a response signal to the invitation request.

On the other hand, when the channel available to the P2P-CL 103 is included, in step F525, the analysis unit 402 confirms an invitation flag. If the wireless network is the non-persistent group, the analysis unit 402 analyzes either one or both of the P2P group ID 307 and the P2P device information 308. Then, in step F528, the analysis unit 402 confirms the MAC address, namely the identification information of the P2P-GO that established the wireless network 56. In step F529, the determination unit 403 determines whether the MAC address of the P2P-GO is the same as the MAC address of the P2P-GO that established the wireless network 53 to which the P2P-CL 103 connected immediately before then.

If the MAC addresses of the P2P-GOs of the wireless networks 53 and 56 are the same, the determination unit 403 compares the P2P group disconnection period with the automatic connection permission time period. If the P2P group disconnection period is shorter than the automatic connection permission time period, in step F530, the P2P connection processing unit 406 performs connection processing to the wireless network 56. More specifically, in step F530, the P2P connection processing unit 406 performs communication parameter setting (provision discovery, WPS), transmission of a connection request (association), and authentication processing (authentication).

When the above-described conditions are not satisfied, in step F531, the confirmation unit 408 confirms with a user whether to accept participation in the wireless network 56.

If the user accepts the participation, in step F532, the P2P connection processing unit 406 performs connection processing to the wireless network 56. Whereas, if the user refuses the participation, in step F533, the P2P-CL 103 does not perform connection processing to the wireless network 56. In this case, the P2P-CL 103 does not connect to the dual apparatus 101.

In step F506 and subsequent steps, if the dual apparatus 101 cannot find a desired wireless network as a result of the wireless network search in all of the available channels, the dual apparatus 101 does not disconnect from the P2P-CL 103 and continues the connection thereto.

According to the present exemplary embodiment, after the STA function of the dual apparatus 101 finds the new wireless network in step F517, the wireless network 53 established by the P2P-GO is terminated in step F518. Instead of this processing, the dual apparatus 101 may terminate the wireless network 53 at a timing when detecting disconnection from the wireless network 52 in step F505. In this case, the confirmation in step F506 of whether the P2P-CL exists in the wireless network 53 established by the P2P-GO and the NoA processing in steps F507, F510, and F513 can be omitted.

After the STA function of the dual apparatus 101 completes the connection to the desired wireless network by roaming, in step F521, the P2P-GO function of the dual apparatus 101 establishes the wireless network 56 and, in step F522, performs invitation request processing. Alternatively, after the wireless network search in all of the available channels is completed without finding the desired wireless network, in step F521, the P2P-GO function of the dual apparatus 101 establishes the wireless network 56, and, in step F522, performs the invitation request processing.

According to the present exemplary embodiment, the P2P group disconnection period is included in a reconnection condition that requires no user operation, however, determination may be made only by comparison between the MAC addresses of the P2P-GOs of the P2P group without including the P2P group disconnection period.

FIG. 6 is a flowchart illustrating behaviors of the wireless communication apparatus 103 from when receiving a P2P invitation request and determining whether to connect to the wireless network until when participating in the P2P group. Processing in each step described below is realized by the control unit 404 reading and executing a program stored in the storage unit 405.

In step S601, the reception unit 411 receives a P2P invitation request. In step S602, the analysis unit 402 analyzes contents of the P2P invitation request frame. In step S603, the analysis unit 402 confirms whether channels described in the operating channel and the channel list include a communicable channel to the wireless communication apparatus 103.

If a communicable channel is not included in the described channels (NO in step S603), in step S611, the transmission unit 412 transmits an invitation response indicating an error to the invitation request transmission source. At that time, status information (Status) of the wireless communication apparatus 103 is added to a P2P invitation response. The Status includes three items, namely an attribute ID, a status code length, and a status code.

When the wireless communication apparatus 103 receives the invitation request without problem and is in a state capable of starting communication processing with the invitation request transmission source, a status code value becomes zero indicating success. When the wireless communication apparatus 103 cannot start communication processing, an appropriate status code value is selected from two to eleven indicating failure. If there is no communicable channel, the status code value becomes seven. Thus, in step S611, an invitation response including the status code value seven is transmitted to the invitation request transmission source. Then in step S615, the wireless communication apparatus 103 does not perform processing necessary for connection, such as the communication parameter setting and the authentication procedure, and does not communicate with the invitation request transmission source any further.

If a communicable operating channel is included in the invitation request (YES in step S603), the analysis unit 402 analyzes the invitation flag. In step S604, the analysis unit 402 confirm whether the P2P group to which the invitation request transmission source belongs is the persistent group or the non-persistent group.

A case when the invitation request is transmitted from the non-persistent group (NO in step S604) is described first.

In this case, in step S605, the transmission unit 412 transmits an invitation response including a status code value zero to the invitation request transmission source. Then, in step S606, the determination unit 403 confirms the P2P group disconnection period. If the P2P group disconnection period is being measured and within the automatic connection permission time period (YES in step S606), the determination unit 403 further determines the following condition. In step S607, the determination unit 403 determines whether the MAC address of the P2P-GO in the P2P group previously connected is the same as the MAC address of the P2P-GO in the P2P group to which the invitation request requests to connect. The present exemplary embodiment is not limited to the above-described configuration, and the determination unit 403 may determine whether the P2P group BSSID of the P2P group previously connected is the same as the P2P group BSSID of the P2P group to which the invitation request requests to connect. Further, instead of or in addition to the P2P group BSSID, conformity of the P2P group IDs or the P2P device information pieces may be determined. Accordingly, the determination unit 403 determines whether the wireless communication apparatus 103 has ever connected to the P2P group to which the invitation request requests to connect.

If the MAC addresses are the same (YES in step S607), then in step S608, the P2P connection processing unit 406 performs connection processing to start communication with the P2P group that transmitted the invitation request without performing confirmation processing to a user by the confirmation unit 408. In other words, when the determination results in steps S606 and 607 are both YES, the confirmation unit 408 is restrained from performing the confirmation processing to a user. Accordingly, a user does not need to perform unnecessary operation, and convenience for a user can be improved. Confirmation of the P2P group disconnection period and the MAC address of the P2P-GO may be performed in a reverse order.

The P2P group disconnection period is not measured if the wireless communication apparatus 103 never connects to the non-persistent group as the P2P-CL or if a long time has elapsed since the wireless communication apparatus 103 disconnected from the non-persistent group. If the P2P group disconnection period is longer than the automatic connection permission time period, there is a possibility that a state of the P2P-GO is changed. Thus, in such a case, the confirmation unit 408 displays a message for asking a user to accept connection to the P2P group to which the invitation request transmission source belongs and prompts the user to select acceptance or refusal of connection. Accordingly, in step S609, the confirmation unit 408 obtains acceptance to participant in the P2P group from the user. In other words, the confirmation unit 408 confirms with the user regarding acceptance or refusal of connection according to the determination result in step S606.

If the MAC address of the P2P-GO in the P2P group previously connected is not the same as the MAC address of the P2P-GO in the P2P group to which the invitation request requests to connect (NO in step S607), in step S609, the confirmation unit 408 performs confirmation.

In step S610, if the user accepts connection (YES in step S610), in step S608, the wireless communication apparatus 103 performs the communication parameter setting, the connection request, and the authentication procedure with respect to the invitation request transmission source to connect to the P2P group. In other words, the wireless communication apparatus 103 requests connection to the P2P group (the wireless network) in response to the confirmation result by the user and connects to the P2P group.

On the other hand, if the user does not accept connection (NO in step S610), in step S615, the wireless communication apparatus 103 disconnects communication with the P2P group that transmitted the invitation request without performing the communication parameter setting and the authentication procedure. Measurement of the P2P group disconnection period may be stopped and initialized when the automatic connection permission time period has elapsed or after the wireless communication apparatus 103 participates in the persistent group.

When the wireless communication apparatus 103 connects to the P2P group and starts communication therewith in step S608, the authentication procedures, such as provision discovery and WPS, need to be executed. However, these processing may be omitted if the wireless communication apparatus 103 connects to a group of which P2P-GO is the same as that in the P2P group to which the wireless communication apparatus 103 connected immediately before then, and it can be confirmed that the communication parameters are the same based on the P2P group ID.

Next, a case when the P2P invitation request is transmitted from the P2P-GO or the P2P-CL of the persistent group (YES in step S604) is described.

In this case, in step S612, the determination unit 403 determines whether the same persistent group exists in the P2P group ID stored in the storage unit 405. More specifically, the determination unit 403 determines whether the P2P group BSSID stored in the storage unit 405 is the same as the P2P group BSSID of the persistent group to which the P2P invitation request requests to connect. Further, instead of or in addition to the P2P group BSSID, conformity of the P2P group IDs or the MAC addresses of the P2P-GOs in the persistent group may be determined.

Accordingly, the determination unit 403 determines whether the wireless communication apparatus 103 has ever connected to the P2P group to which the invitation request requests to connect.

If the wireless communication apparatus 103 has not connected in the past to the P2P group to which the invitation request requests to connect (NO in step S612), the processing proceeds to step S614. In step S614, the transmission unit 412 transmits an invitation response in which a status code value is set to eight indicating an unregistered P2P group. Then in step S615, the wireless communication apparatus 103 disconnects communication with the invitation request transmission source.

On the other hand, in the case of the invitation to the persistent group already registered as the result of the analysis of the invitation request contents (YES in step S612), the following processing is performed. In step S613, the transmission unit 412 transmits an invitation response in which a status code value is set to zero indicating success. Then in step S608, the P2P connection processing unit 406 starts communication with the invitation request transmission source. In this case, the communication parameter has already been stored, and it is not necessary to newly perform the sharing processing. Thus, only the connection request and the authentication procedure are performed.

The first exemplary embodiment can reduce a case that requires a user operation when an invitation request is received, and thus operability of the user can be improved.

In FIG. 5, an example is described in which the P2P-GO that transmits a P2P invitation request is the dual apparatus and transmits the invitation request since the P2P-GO needs to change the channel. However, the present exemplary embodiment is not limited to this example and can be applied to a case when the P2P-GO does not perform the concurrent operation. In addition, if transmission of the invitation request is not caused by the change in the channel, automatic connection to the P2P group to which the invitation request transmission source belongs can be performed without confirming with a P2P-GO user.

A user operation at the time of reception of an invitation request can be omitted, for example, if the wireless network is the one connected in the past and the wireless network has a predetermined SSID (a network identifier) specified by a user. In this case, when an invitation signal to a wireless network specified by the user is received, the wireless communication apparatus 103 can participate in the relevant wireless network by omitting the user operation.

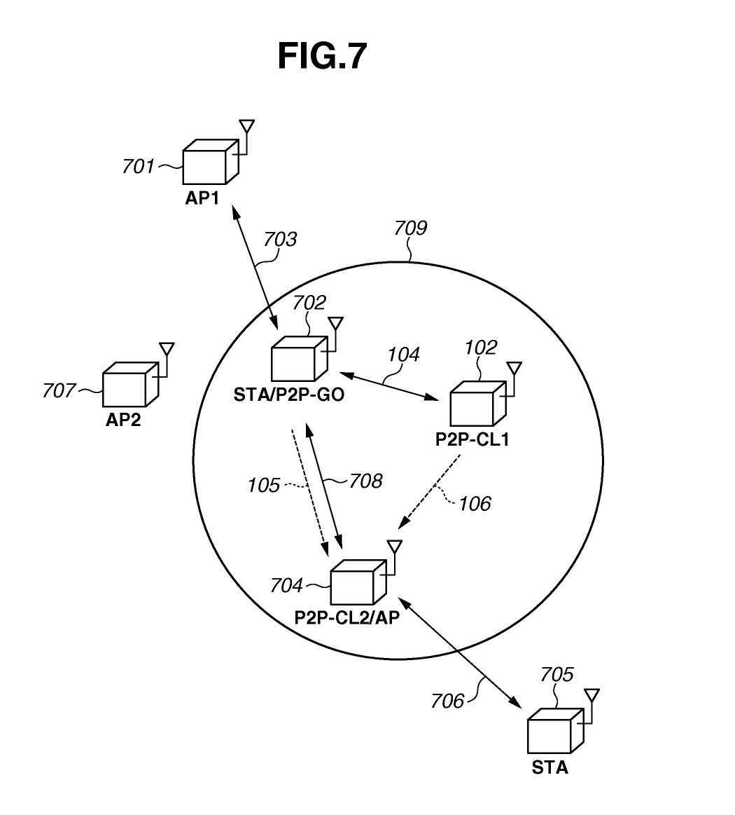

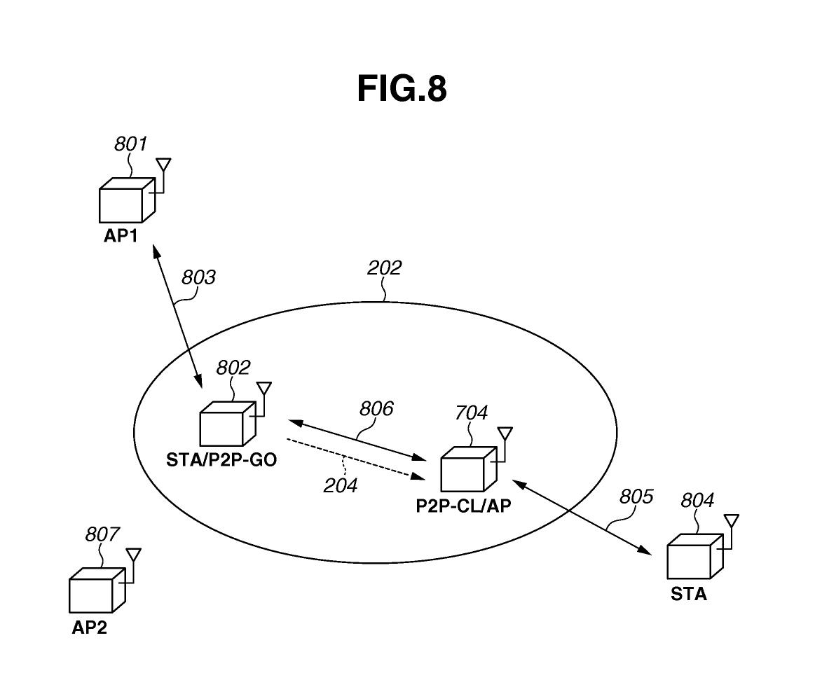

Next, a second exemplary embodiment will be described in detail below with reference to the drawings. FIGS. 7 and 8 illustrate configurations of network systems according to the second exemplary embodiment. Constituent components similar to those described in the first exemplary embodiment are denoted by the same reference numerals and their descriptions are not repeated.

FIG. 7 is the system configuration in a case where a wireless communication apparatus 702 that concurrently operates the P2P-GO function and the STA function forms a P2P group in the non-persistent mode.

A wireless communication apparatus 704 concurrently operates the AP function and the P2P-CL function. The wireless communication apparatus 704 includes function blocks illustrated in FIG. 4.

The constituent components 102 and 104 to 106 in FIG. 7 are the same as those in FIG. 1, and the constituent components 202 and 204 in FIG. 8 are the same as those in FIG. 2, and thus their descriptions are not repeated.

Communication channels of APs 701 and 707 and APs 801 and 807 are each set to different values.

The wireless communication apparatus 702 is a dual apparatus concurrently operating the STA function and the P2P-GO function and performs communication between the AP 701 in an infrastructure mode 703.

An STA 705 performs communication 706 with the AP function of the wireless communication apparatus 704.

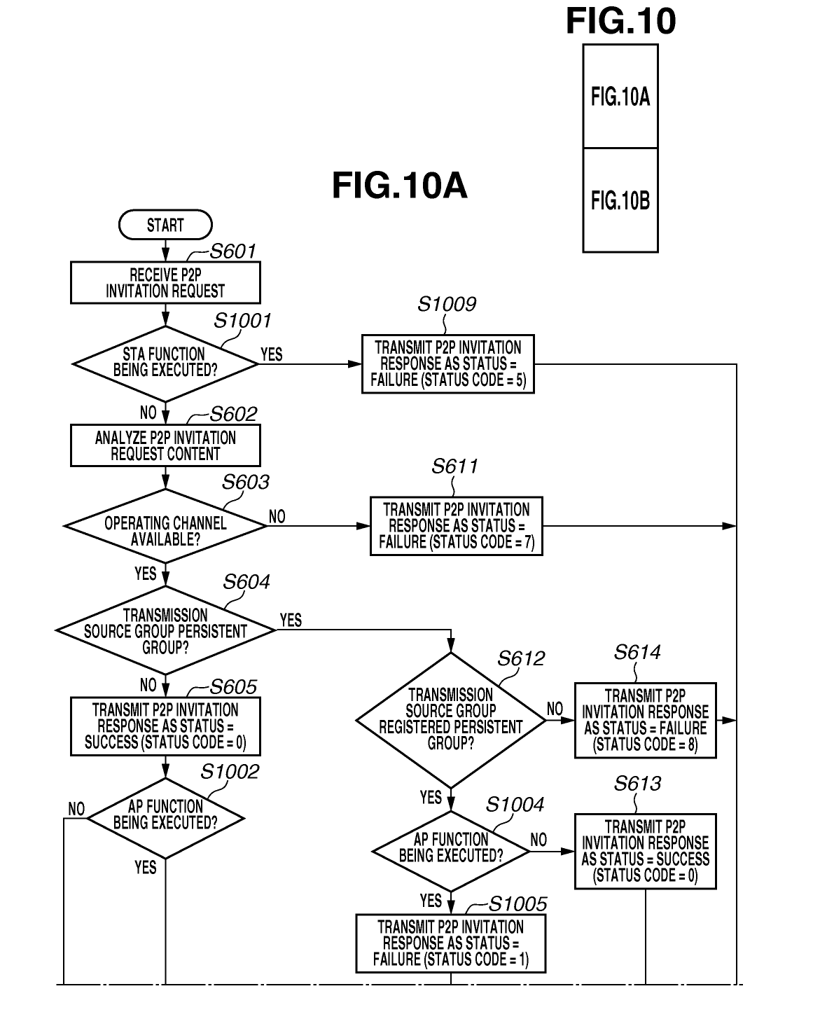

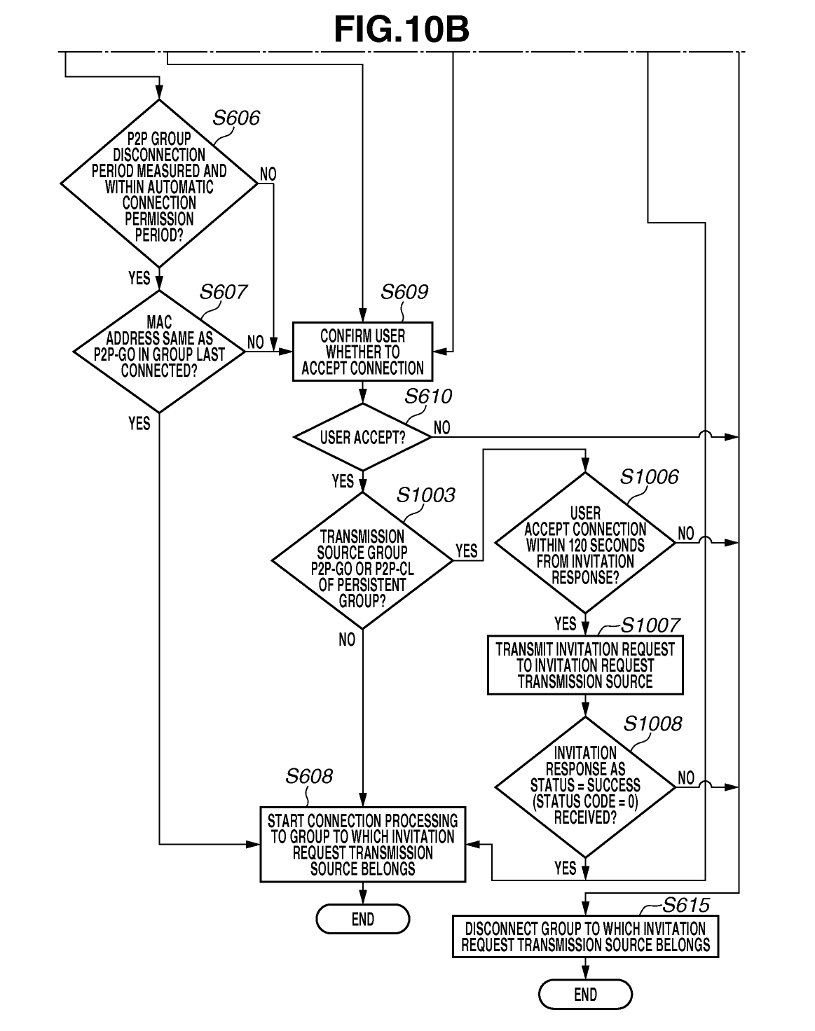

The AP 707 is a roaming destination of the STA function of the dual apparatus 702. Regarding the wireless communication apparatus 704, a dual apparatus that concurrently operates the STA function and the P2P-CL function in addition to the concurrent operation illustrated in FIG. 7 can serve as a wireless communication apparatus that realizes processing in FIG. 10 described below. In that case, the STA 705 serves as an AP.

FIG. 8 is the system configuration in a case where a wireless communication apparatus 802 that concurrently operates the P2P-GO function and the STA function forms a P2P group in the persistent mode.

In FIG. 8, the wireless communication apparatus 802 is a dual apparatus concurrently operating the STA function and the P2P-GO function. The STA function of the wireless communication apparatus 802 performs infrastructure communication 803 with the AP1 801. An STA 804 communicates with the wireless communication apparatus 704. The AP function of the wireless communication apparatus 704 performs infrastructure communication 805 with the STA 804. The STA function of the dual apparatus 802 changes a connection AP from the AP1 801 to the AP2 807 by roaming.

In FIG. 8, the wireless communication apparatus 704 concurrently operates the AP function and the P2P-CL function. However, the concurrent operation is not limited to these functions, and the wireless communication apparatus 704 may perform the concurrent operations of the STA function and the P2P-CL function, the STA function and the P2P-GO function, and the AP function and the P2P-GO function.

If the wireless communication apparatus 704 is the dual apparatus performing the STA function and the P2P-CL function, the infrastructure communication 805 is performed with the AP. If the wireless communication apparatus 704 is the dual apparatus performing the STA function and the P2P-GO function, the dual apparatus 802 performs the STA function and the P2P-CL function, and the infrastructure communication 805 is performed with the AP. If the wireless communication apparatus 704 is the dual apparatus performing the AP function and the P2P-GO function, the dual apparatus 802 performs the STA function and the P2P-CL function, and the infrastructure communication 805 is performed with the STA.

A configuration of an invitation request frame and a function configuration according to the present exemplary embodiment are respectively the same as those in FIGS. 3 and 4 according to the first exemplary embodiment, and thus their descriptions are not repeated.

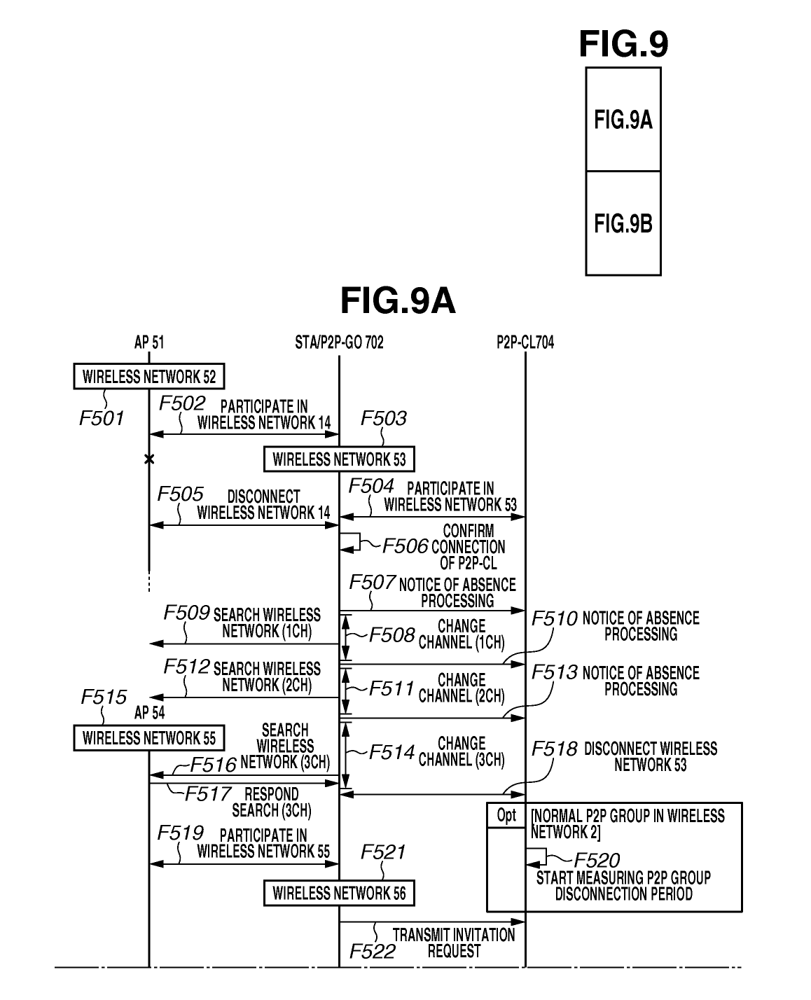

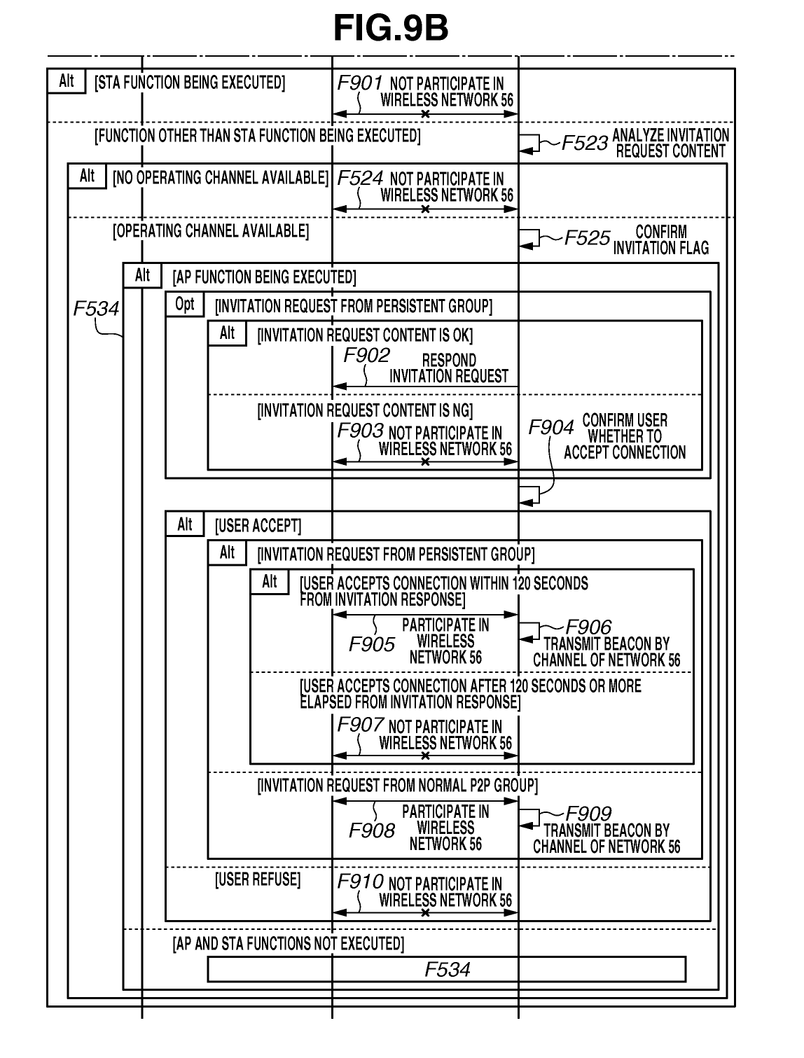

FIG. 9 (including FIGS. 9A and 9B) is a sequence diagram when the dual apparatus 702 performs roaming from the wireless network 52 to the wireless network 55 in the case where the wireless communication apparatus 704 (i.e., a P2P-CL 704) concurrently operates the P2P-CL function and the AP function or the STA function. First, the dual apparatus 702 connects to the wireless network 52 established by the AP 51 using the STA function, and the P2P-CL 704 connects to the wireless network 53 established by the P2P-GO function. Then, when the dual apparatus 702 performs roaming from the wireless network 52 to the wireless network 55, the P2P-GO function newly establishes the wireless network 56.

According to the present exemplary embodiment, behaviors of the wireless communication apparatus 704 when receiving an invitation request are classified into three cases, namely when the STA function is being executed, when the AP function is being executed, and when both functions are not being executed. The classification is based on use cases of communication using the P2P group and communication in the infrastructure mode via the AP. Basically, communication using the P2P group is used only for exchange of data, communication in the infrastructure mode is used for a case in which the connection is constantly maintained. Thus, connection via the AP is prioritized than communication using the P2P group in terms of maintaining of connection. If an invitation request recipient apparatus performs concurrent operation, the recipient apparatus should handle the invitation request so as to maintain communication between the AP and the STA in priority to communication between the P2P-GO and the P2P-CL.

If the invitation request recipient 704 concurrently operating the AP function follows the invitation request including a channel change, the AP function side also needs to change the channel. However, when the AP function side connects to the STA, the STA cannot correspond to the new channel of the AP side in some cases. Thus, the channel change should be confirmed with a user.

If the invitation request recipient 704 concurrently operating the STA function follows the invitation request including a channel change, the STA function side also need to change the channel. This change in the channel means disconnection from the AP. Since maintaining the connection between the AP and the STA is prioritized, the wireless communication apparatus 704 concurrently operating the STA function cannot accept the invitation request.

Processing in steps F501 to F525, and F534 (F526 to F533) in FIG. 9 are the same as those in FIG. 5, and thus their descriptions are not repeated.

The P2P-CL 704 concurrently operating the STA function does not disconnect the communication with the AP in response to the invitation request. This is because the connection between the AP and the STA is prioritized to be maintained. Thus, in step F901, the P2P-CL 704 does not connect to the wireless network 56 if the invitation request is received.

When the P2P-CL 704 concurrently operates the AP function or operates only the P2P-CL function, in step F523, the P2P-CL 704 analyzes contents of the received invitation request.

Then, the P2P-CL 704 confirms whether an operating channel described in the invitation request frame is available to the P2P-CL 704. If only an unavailable channel is described, in step F524, the P2P-CL 704 transmits an invitation response indicating an error to the P2P-GO 702 and does not connect to the P2P-GO 702.

Next, in step F525, the P2P-CL 704 confirms an invitation flag in the invitation request frame. If the invitation flag is a request for connection to the persistent group, the P2P-CL 704 confirms whether the connection to a group same as the already registered persistent group is requested. When performing the concurrent operation of the AP function, the P2P-CL 704 does not communicate with the invitation request transmission source without acceptance from a user even if the persistent group is already registered. Thus, in step F902, the P2P-CL 704 transmits an invitation response indicating that acceptance from a user is required. Then, the P2P-CL 704 displays a message on a user interface for asking a user to accept connection to the P2P group to which the invitation request transmission source belongs including the change in the channel of the AP function. In step F904, the P2P-CL 704 thus prompts the user to select acceptance or refusal and waits for connection acceptance from the user.

When the persistent group is not registered as a result of the analysis of the invitation request, the P2P-CL 704 transmits an invitation response indicating an error to the invitation request transmission source. Then, in step F903, the P2P-CL 704 disconnects communication with the invitation request transmission source. Registration of the persistent group and handling of the channel may be confirmed in any order.

If the invitation flag indicates that the invitation request is a request for participation in the non-persistent group, in step F904, the P2P-CL 704 waits for connection acceptance from the user regarding the participation in the wireless network 56. In this regard, connection acceptance is asked for a user by displaying a confirmation message on the user interface including the need for the channel change of the AP function.

When the user accepts the participation in the P2P group, in step F908, the P2P-CL 704 starts performing the communication parameter setting and the authentication procedure necessary for connection if the P2P group is the non-persistent group. When the P2P-CL 704 completes the connection to the P2P group and the change in the channel of the AP function, in step F909, the AP function transmits a beacon to notify surrounding wireless communication apparatuses of a current channel of its own.

Next, a case when the P2P group accepted by a user is the persistent group is described. In this case, in step F905, if the user acceptance is received within 120 seconds from transmission of a P2P invitation response, the P2P-CL 704 start processing of the wireless network 56. In addition, the P2P-CL 704 completes the change in the channel of the AP function. Then, in step F906, the P2P-CL 704 transmits a beacon to notify surrounding wireless communication apparatuses of a current channel of its own. In step F907, if the user acceptance is not received within 120 seconds from transmission of the P2P invitation response, the P2P-CL 704 does not connect to the P2P-GO 702 without transmitting any signal therefrom.

In step F910, if the user refuses to participate in the P2P group, the P2P-CL 704 continues the AP function to maintain the connection to the STA without connecting to the wireless network 56 regardless of the non-persistent group or the persistent group.

In step F534, if the wireless communication apparatus 704 does not perform the concurrent operation, behaviors are similar to those in the first exemplary embodiment.

FIG. 10 (including FIGS. 10A and 10B) is a flowchart illustrating behaviors of the dual wireless communication apparatus 704 from when receiving a P2P invitation request and determining whether to connect to the wireless network until when participating in the P2P group. Processing in each step described below is realized by the control unit 404 reading and executing a program stored in the storage unit 405.

The processing in steps S601 to S615 in FIG. 10 are the same as those in FIG. 6, and thus their descriptions are not repeated. The behaviors described in those steps are the same as when the wireless communication apparatus 704 does not execute the AP function and the STA function.

In step S601, a P2P invitation request is received, and in step S1001, if the STA function is being executed (YES in step S1001), the P2P-CL 704 does not respond to the invitation request. Thus, in step S1009, the P2P-CL 704 sets a status code value in an invitation response to five indicating that an unachievable request is received. Then, the P2P-CL 704 transmits the invitation response including the set value to the invitation request transmission source. In this regard, the status code value may be set to three indicating that connection of the P2P-CL 704 is limited. In step S615, communication with the invitation request transmission source is terminated by the transmission of the invitation response.

If the STA function is not being executed (NO in step S1001), in step S602, the P2P-CL 704 analyzes contents of the P2P invitation request to confirm an operating channel. In step S603, the analysis unit 402 confirms whether channels described in the operating channel and the channel list include a communicable channel to the P2P-CL 704. If a communicable channel is not included in the described channels (NO in step S603), the P2P-CL 704 cannot connect to the P2P group to which the invitation request transmission source belongs. Thus, in step S611, the P2P-CL 704 transmits an invitation response including a status code value seven indicating an operating channel error to the invitation request transmission source. In this case, in step S615, the communication with the invitation request transmission source is also terminated by the transmission of the invitation response.

If it is confirmed that the operating channel described in the invitation request is a communicable channel to the P2P-CL 704 (YES in step S603), in step S604, the P2P-CL 704 confirms the type of the group to which the invitation request requests to connect. If it is the persistent group (YES in step S604), in step S612, the P2P-CL 704 determines whether the invitation request transmission source is the same with the P2P-GO of the persistent group stored in the storage unit 405. The above-described determination is performed regardless of the AP function is being executed or not. If it is determined that the invitation request transmission source is not the P2P-GO of the persistent group (NO in step S612), in step S614, the P2P-CL 704 transmits an invitation response including a status code value eight as with the case of the first exemplary embodiment. Then, in step S615, the P2P-CL 704 terminates the communication with the invitation request transmission source. If it is confirmed that the name of the persistent group is already registered (YES in step S612), the processing proceeds to step S1004. If the AP function is not being executed (NO in step S1004), in step S613, the P2P-CL 704 transmits an invitation response including a status code value zero indicating success. Then, in step S608, the P2P-CL 704 starts the authentication procedure to communicate with the invitation request transmission source. If the AP function is being executed (YES in step S1004), the P2P-CL 704 needs connection acceptance from the user. Thus, in step S1005, the P2P-CL 704 transmits an invitation response in which a status code value is set to one indicating that the P2P-CL 704 is not ready to correspond to the received invitation request frame. According to the present exemplary embodiment, when a user accepts the connection, the P2P-CL 704 can start the processing for connecting to the invitation request transmission source. Thus, when the status code value is one, the P2P-CL 704 confirms with a user to accept the connection. In this regard, in step S609, the P2P-CL 704 displays a message on a user interface screen for confirming with a user to accept connection including that the invitation request recipient needs to change the channel of the AP function by the communication with the invitation request transmission source.

Processing to be performed when a user accepts communication with the invitation request transmission source within 120 seconds from transmission of the invitation response (in steps S610, S1003, and S1006) is first described. In this case, in step S1007, the P2P-CL 704 transmits an invitation request to the invitation request transmission source. In step S1008, if the P2P-CL 704 can receive an invitation response from the partner apparatus (YES in step S1008), in step S608, the P2P-CL 704 starts communication with the partner apparatus.

On the other hand, regarding the following cases, the P2P-CL 704 terminates the communication with the invitation request transmission source in step S615. A first case is that a user accepts connection after 120 seconds or more elapsed from the transmission of the invitation response (NO in step S1006). The other case is that a user accepts connection within 120 seconds and the invitation request is transmitted, however, a status code value of a response to the relevant invitation request is not success.

In step S604, if the invitation request is a request for connection to the non-persistent group (NO in step S604), in step S605, the P2P-CL 704 transmits an invitation response. Then, in step S1002, if the AP function is being executed (YES in step S1002), in step S609, the P2P-CL 704 confirms with a user to accept communication with the invitation request transmission source via the user interface screen of the invitation request recipient or the like. If the user accepts communication (YES in step S610), the P2P-CL 704 performs provision discovery and WPS that are parameter setting procedures for connection and the authentication procedure. Thus, the P2P-CL 704 connects to the invitation request transmission source. If the P2P-CL 704 connects to a group of which P2P-GO is the same as that in the P2P group to which the P2P-CL 704 connected immediately before then, the communication parameter setting may be omitted. In this case, the communication parameter of the P2P group to which the P2P-CL 704 connected immediately before then is reused.

The second exemplary embodiment can reduce a case that requires a user operation while maintaining priority of connection desired by a user when an invitation request accompanied by a channel change is received, and thus operability of the user can be improved.

According to the present disclosure, a wireless communication apparatus can connects to a wireless network while simplifying a user operation.

### Other Embodiments

Additional embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-102170, filed May 16, 2014, which is hereby incorporated by reference herein in its entirety.

What is claimed is:

1. A communication apparatus comprising:
a storage unit configured to store first information corresponding to an apparatus that establishes a predetermined wireless network;
a reception unit configured to receive an invitation request signal indicating an invitation to a wireless network; and
a confirmation unit configured to, in a case where a wireless network associated with the invitation request signal is not the predetermined wireless network, confirm whether to connect to the wireless network,
wherein in a case where a wireless network associated with the invitation request signal is the predetermined wireless network, confirmation is omitted.

2. The communication apparatus according to claim 1 further comprising a request unit configured to request connection to a wireless network associated with the invitation request signal.

3. The communication apparatus according to claim 1 further comprising:
a determination unit configured to determine whether a wireless network associated with the invitation request signal is the predetermined wireless network,
wherein the confirmation unit confirms according to a determination result by the determination unit.

4. The communication apparatus according to claim 1, wherein, in a case where a predetermined time period has elapsed from when the communication apparatus disconnects from the predetermined wireless network, the confirmation unit confirms, even if a wireless network associated with the invitation request signal is the predetermined wireless network.

5. The communication apparatus according to claim 1 further comprising a transmission unit configured to, in a case where the reception unit receives the invitation request signal, transmit a response signal with respect to the invitation request signal.

6. The communication apparatus according to claim 5, wherein the transmission unit transmits the response signal corresponding to the first information.

7. The communication apparatus according to claim 1, wherein the communication apparatus operates as a group owner specified by a wireless communication protocol.

8. The communication apparatus according to claim 1, wherein the communication apparatus operates as a client specified by a wireless communication protocol.

9. The communication apparatus according to claim 1, wherein the invitation request signal is an invitation request signal specified by a wireless communication protocol.

10. The communication apparatus according to claim 1, wherein the first information includes at least identification information of an apparatus that manages the predetermined wireless network and a group type of the predetermined wireless network.

11. The communication apparatus according to claim 10, wherein the identification information is a media access control (MAC) address of a group owner specified by a wireless communication protocol that manages the predetermined wireless network.

12. The communication apparatus according to claim 10, wherein the group type is information indicating whether the predetermined wireless network is a persistent group specified by a wireless communication protocol.

13. The communication apparatus according to claim 1 further comprising a sharing unit configured to perform processing to share a communication parameter for connecting to a wireless network associated with the invitation request signal according to a confirmation result by the confirmation unit.

14. The communication apparatus according to claim 1, wherein the predetermined wireless network is a wireless network to which the communication apparatus previously connected.

15. A method for controlling a communication apparatus, the method comprising:
storing first information corresponding to an apparatus that establishes a predetermined wireless network;
receiving an invitation request signal indicating an invitation to a wireless network with respect to the communication apparatus; and
confirming, in a case where a wireless network associated with the invitation request signal is not the predetermined wireless network, whether to connect to the wireless network,
wherein in a case where a wireless network associated with the invitation request signal the predetermined wireless network, confirmation is omitted.

16. A computer-readable storage medium storing computer executable instructions for causing a computer to execute a method for controlling a communication apparatus, the method comprising:
storing first information corresponding to an apparatus that establishes a predetermined wireless network;
receiving an invitation request signal indicating an invitation to a wireless network with respect to the communication apparatus; and
confirming, in a case where a wireless network associated with the invitation request signal is not the predetermined wireless network, whether to connect to the wireless network,
wherein in a case where a wireless network associated with the invitation request signal the predetermined wireless network, confirmation is omitted.
